(19) United States
(12) Patent Application Publication
(10) Pub. No.: US 2010/0135779 A1
(43) Pub. Date: Jun. 3, 2010

(54) SEMI-FINISHED PRODUCT FOR PRODUCING A REPAIRED BLADE FOR A GAS TURBINE AND REPAIR METHOD FOR REPAIRING A BLADE FOR A GAS TURBINE

(75) Inventor: Bernd Stimper, Kleinmachnow (DE)

Correspondence Address: HOWISON & ARNOTT, L.L.P, P.O. BOX 741715, DALLAS, TX, 75374-1715, US

(73) Assignee: MTU AERO ENGINES, GMBH, Munich (DE)

(21) Appl. No.: 12/597,893

(22) PCT Filed: Apr. 18, 2008
(86) PCT No.: PCT/DE08/00653

§ 371 Date: Oct. 27, 2009

(30) Foreign Application Priority Data
Apr. 27, 2007 (DE) 10 2007 019 949.1

(51) Int. Cl. F01D 9/02; B23P 6/00

(52) U.S. Cl. 415/208.1; 29/889.1

(57) ABSTRACT

The invention relates to a semi-finished product for producing a repaired blade for a gas turbine. Said semi-finished product comprises a first part (10) and a second part (12) firmly connected to the first part (10), the first part (10) having at least one recess (18) into which the second part (12) projects. The invention also relates to a method for repairing a blade of a gas turbine. Said method comprises the following steps: applying a first part (10) and making a recess (18), especially a groove (18) into said first part (10); applying a second part (12); inserting the second part (12) into the first part (10) in such a manner that the second part (12) or at least one section of the second part (12) projects into the recess (18) or groove (18); and connecting, especially welding, the first part (10) to the second part (12) in such a manner that the first part (10) and the second part (12) are non-detachably interconnected after said connection.

### CROSS-REFERENCE TO RELATED APPLICATIONS

This application is a U.S. National Phase application submitted under 35 U.S.C. §371 of Patent Cooperation Treaty application serial no. PCT/DE2008/000653, filed Apr. 18, 2008, and entitled SEMI-FINISHED PRODUCT FOR PRODUCING A REPAIRED BLADE FOR A GAS TURBINE AND REPAIR METHOD FOR REPAIRING A BLADE FOR A GAS TURBINE, which application claims priority to German patent application serial no. DE 10 2007 019 949.1, filed Apr. 27, 2007, and entitled HALBZEUG ZUM ERZEUGEN EINER REPARIERTEN SCHAUFEL FÜR EINE GASTURBINE UND REPARATURVERFAHREN FÜR DIE REPARATUR EINER SCHAUFEL FÜR EINE GASTURBINE, the specifications of which are incorporated herein by reference in their entireties.

### TECHNICAL FIELD

The invention concerns a semi-finished product for producing a repaired vane for a gas turbine as well as a procedure for the repair of a vane of a gas turbine.

### BACKGROUND

A repair procedure for gas turbine components, namely damaged vane blades of turbine machines, is already known from the German patent DE 43 27 189 A1.

According to the repair procedure proposed there which is provided for the top and edge area of damaged vane blades, damaged areas of turbine machines are cut off down to an undamaged vane blade stub and finally the repair surface of the vane blade stub is prepared for stub welding. Then a repair plate of constant thickness exceeding maximum profile depth of the vane by somewhat more than 50% is tack-welded at the repair surface to an end stub fitted to the repair surface. After that, the vane blade stub and the repair plate are then welded by butt welding. Finally, the root gap and the repair plate are worked to the profile contour of the vane blade stub and to the desired vane blade profile. An embodiment of the procedure disclosed there is described in detail with the aid of FIGS. 1a and 2.

A disadvantage of the design known from DE 43 27 189 A1 is that standardization measures are at least in this case made considerably more difficult, so that expensive jigs for aligning the vane blade stub to the repair part as well as with a high number of expensive tack welds should be dispensed with.

Against this background, the task of the invention is to create an opportunity for repairing vanes for gas turbines, by enabling the vane remnant and the repair part to be positioned in a relatively simple manner, reproducibly if necessary, and as correctly as possible with respect to one another without this requiring jigs, which are technologically particularly expensive.

### SUMMARY

According to the invention, a semi-finished product in particular is proposed for producing a repaired vane for a gas turbine according to selected claims. A repair procedure according to the invention is the object of other claims. Preferred teachings are the object of the subclaims.

Also, in particular, a semi-finished product is proposed for producing a repaired vane for a gas turbine which exhibits a first part as well as a second part. At the same time, the first part is firmly attached to the second part, preferably welded, to be precise. The vane can, for example, be a turbine vane or a compressor vane. It can also be provided that the vane is a vane of a bladed integral rotor, such as a BLISK (a technical term derived from “bladed disk”) or a BLING (a technical term derived from “bladed ring”).

The firm attachment between the first part and the second part is preferably in the area of the floor of the recess or at the base of the groove and/or in the area of the groove sidewall.

It can be provided that the first part is a vane stub or a remnant vane or a remnant vane blade and that the second part is a repair part provided with dimensioning. In the aforementioned cases, the repair part is in particular such that it completes the vane stub or the remnant vane or the vane blade-stub or blade-remnant to a vane blade or a vane, if the allowance is left out of consideration. But it can also be provided that several repair parts are provided which in combination present the function of completion in the aforementioned sense.

It is provided that the first part exhibits or forms at least one recess, into which the second part projects. The recess can, for example, be a groove. In a more preferable embodiment, the recess or the groove is provided in the vane stub or in the remnant vane. In a recess provided as a groove, it can in particular be provided that this is tapered, widening in the direction of the base of the groove, especially tapering to a point. But it may also be that, at the base of the groove, the groove presents a cross-section that remains constant.

According to an especially preferred embodiment, it is intended that a recess in the first or in the second part, be provided, in particular a groove, into which the other part respectively projects, that is, into which the other part respectively extends, whereby the first part and the second part are welded to one another at the base of the groove and/or in the area of the groove sidewall or inside this groove or recess. The groove can thus, for example, be designed or shaped in an aforementioned manner. Hence especially preferred welding occurs from the outside, particularly, to be precise, so that the power is supplied from one direction which is convenient, at an angle to a perpendicular or to at least one of the perpendiculars occurring at the base of the groove, whereby it is particularly provided that the welding is done or occurs in the area of the base of the groove and/or in the area of the groove sidewall.

Furthermore, a procedure is proposed for the repair of a vane of a gas turbine. With this, the vane can, however, be a compressor vane or a turbine vane or a vane of a bladed integral rotor such as a BLISK or a BLING. Here the gas turbine is, in an advantageous embodiment, also a flight propulsion mechanism.

According to the procedure, it is provided that a first part, such as a vane remnant or vane stub or remnant vane or remnant vane blade or integral rotor with a vane blade section removed, is applied, and a recess, such as a groove, for instance, is introduced into this. Furthermore, a second part, such as a repair part, is applied in parallel either simultaneously or overlapping either before or after the aforementioned step. It is to be noted that it can be alternatively provided that the first part is such a part as was mentioned as an example for the second part, and the second part is such a part as was mentioned as an example for the first part.

In the procedure according to the invention, it is provided that the second part is inserted into the first part such that the second part or at least a section of this part projects into the recess or the groove. This can be so that the second part comes in contact with the base of the recess or the base of the groove, or so that, especially at least before attaching the first and the second parts, there is a gap free of material between the base of the recess or the base of the groove and the section of the second part projecting into the groove.

Furthermore, according to the procedure, it is provided that the first part is attached to the second part. This attachment can, for instance, be a weld, such as, for instance, a plasma-arc weld or TIG weld or laser-jet weld or electron-beam weld. The attachment in question occurs in particular so that after the attachment or after the attachment process, the first part is connected irremovably to the second part.

In a preferred design, it is provided that the vane stub or the remnant vane or the remnant vane blade or the bladed integral rotor, such as a BLISK or a BLING, is produced with a cut-off part of the vane blade by cutting off at least one, in particular a damaged, section of a vane to be repaired or from one of the vane blades to be repaired.

In a preferred embodiment, the repair part exhibits an oversized amount, which, after attaching to the other part, that is, in particular, a remnant vane or a remnant vane stub or a remnant integral rotor, especially a remnant BLISK or remnant BLING, is shaped to a cut-off section of a vane blade as to its form. This can in particular occur so that the shape thus produced is such that the repair part is fitted to the target contour or the shape is essentially given to the repair part which the cut-off section had, especially as derived from the damaged section.

An especially preferred weld occurs from the outside, to be precise, particularly so that power is supplied from one direction, which is convenient, at a angle to a perpendicular or to at least one of the perpendiculars occurring at the base of the groove, whereby it is in particular provided that the welding is done or occurs in the area of the base of the groove and/or in the area of the groove sidewall.

### BRIEF DESCRIPTION OF THE DRAWINGS

In the following, embodiment examples of the invention will now be clarified using the figures enclosed, in which it is noted that the invention shall not be limited by these embodiments, but further embodiments also fall under the invention. Shown for this are:

FIG. 1 a first embodiment of a semi-finished product according to the invention, in which this product can also be provided by carrying out an example procedure according to the invention; and

FIG. 2 a second embodiment of a semi-finished product according to the invention, in which this product can also be provided by carrying out an example procedure according to the invention.

### DETAILED DESCRIPTION

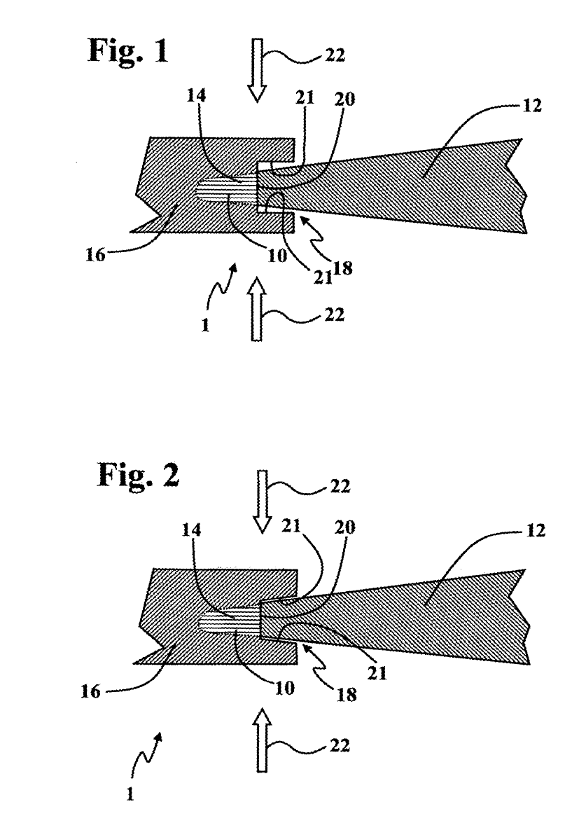

FIG. 1 shows a first semi-finished example product 1 according to the invention, for producing a repaired vane for a gas turbine or turbines and FIG. 2 shows a second semi-finished example product 1 according to the invention, for producing a repaired vane for a gas turbine or turbines.

In FIGS. 1 and 2, designs shown as an example can further be exemplary intermediate stages which proceed within the scope of an example procedure according to the invention. Against this background, using FIGS. 1 and 2, further exemplary embodiments of a procedure according to the invention are clarified.

The following designs refer to both the design according to FIG. 1 and to the design according to FIG. 2, provided that no reference is made to specific differences.

The semi-finished product 1 exhibits a first part 10 and a second part 12, which are partially depicted.

The second part 12 corresponds to a remnant vane or to a remnant vane blade which can also be, if necessary, a component of a BLISK (derived from the technical term “BLaded dISK”).

A section of the first part 10 then forms a repair part for a vane. This is, in particular, such that a damaged area has already been cut out of a vane in advance, which will be filled by an undamaged area essentially identical in shape, so that the undamaged vane being created essentially preserves its original configuration.

In FIGS. 1 and 2, the second part exhibits a uniform shading. The first vane part 10, although it is made as one piece in FIGS. 1 and 2, exhibits areas of different shading in FIGS. 1 and 2, a first of which clarifies a first section 14 of the first part 10 and a second of which clarifies a second section 16 of the first part 10. Then the first section 14 of the first part 10 will indicate the area which corresponds as a result/to the form-fitted repair part, that is, to the section of the repair part which, irrespective of damage, corresponds to the removed area of the vane.

In other words, the first part 10 is a repair part, whereby this repair part exhibits through an oversized amount and after removal of this oversized amount is standardized so that it is indicated by the first section 14.

For simplification, in the following, a repair part is addressed which exhibits an oversized amount. As is readily discernible in FIGS. 1 and 2, the first part 10 exhibits a recess, which in FIGS. 1 and 2 is formed as a groove.

The design according to FIG. 1 is distinguished from the design according to FIG. 1 by the shape of this groove 10.

While the width of the groove in the design according to FIG. 1 is essentially constant in the depth direction, it tapers in the design according to FIG. 2, the width of the groove increasing in the direction of groove depth, that is, in the direction of the base of the groove.

The second part 12 is inserted into the groove being addressed, in the design according to FIGS. 1 and 2, in which this second part 12 is welded to the first part 10 in the area of the base of the groove 20 and in the area of the groove sidewall 21.

These welds occur in particular so that the power supply is brought from one direction, which is at an angle to the direction of groove depth. Such a direction is indicated, as an example, by the arrow 22.

The welding can thus be formed, for example, as TIG welds or laser-jet welds or electron-beam welds or plasma-arc welds.

The welding thus occurs in particular so that in the area of the base of the groove 20 and in the area of the sidewall 21 stretching from the base of the groove to the opening cross-section of the groove, the second part 12 is attached to the first part 10.

In the example procedure according to the invention, in order to bring about the repair of a gas-turbine vane, the first part 10 is first applied in which a recess, namely the groove 18, is introduced into this first part. The second part 12 is then applied. It is noted that the application of the first part 10 and of the second part 12 can be reversed. It can be further provided that a damaged area is removed from the second part 12, that is, this step is likewise a component of an example procedure.

The second part 12 is inserted into the first part 10 such that the second part or a section of the second part 12 projects into the recess or into the groove 18. This is in particular so that the second part 12 comes in contact with the first part 10 in the area of the base of the groove 20. Naturally, affixing of the first part 10 corresponds to the aforementioned insertion for the second part 12.

Finally, the second part 12 is attached to the first part 10, which in this example in particular occurs by welding. The attachment occurs such that the second part 12 is irremovably connected to the first part 10. The second part 12 is, in particular, a remnant vane blade, while the first part 10 is a repair part.

As is readily discernible in the figures, the repair part exhibits an oversized amount. This oversized amount is ultimately removed, in a preferred procedure according to the invention which can occur, for example, by shaving or by laser cutting.

It is in particular provided that a groove is introduced at the front in the repair part 10 used. This groove can, for example, correspond in geometry to the cross-section of the part to be repaired either corresponding in essence or being slightly larger. It can be further provided that the run-up and the run-out areas for the weld procedure on the repair part is so integrated that these must likewise must not be joined to the component to be repaired using expensive jigs or separate tack welds.

At least in one advantageous teaching of the design according to the invention, the position of the repair part is always or more frequently reproducible as state of the art. As a result, it is possible to work with a standardization program. The use of jigs can be omitted.

But in particular it can be made possible that the correct and reproducible positioning of the parts to be repaired or of the repair parts is without the use of a jig or without the use of an expensive jig.

1-10. (canceled)

11. A semi-finished product for producing a repaired vane for a gas turbine, the semi-finished product comprising:
a first part;
a second part firmly attached to the first part; and
wherein the first part includes at least one recess formed therein, into which the second part projects.

12. A semi-finished product according to claim 11, wherein the first part is a vane stub resulting from removal of a damaged portion from a vane for a gas turbine, and the second part is a repair part.

13. A semi-finished product according to claim 11, wherein the second part is a vane stub resulting from removal of a damaged portion from a vane for a gas turbine, and the first part is a repair part.

14. A semi-finished product according to claim 13, wherein the recess is a groove having a depth dimension in the direction of projection of the second part and a width dimension in a direction perpendicular to the direction of projection of the second part.

15. A semi-finished product according to claim 14, wherein the width of the groove is substantially constant in the depth direction.

16. A semi-finished product according to claim 14, wherein the groove is tapered in the depth direction.

17. A semi-finished product according to claim 11, wherein the first part is welded to the second part inside the recess.

18. A method for repairing a vane of a gas turbine, comprising the following steps:
providing a first part;
forming a groove into the first part, the groove having a base, sidewalls and an opening cross-section;
providing a second part;
inserting the second part into the first part such that at least one section of the second part projects into the groove between the sidewalls of the groove; and
attaching the first part to the second part such that, after this attaching, the first part and the second part are connected irremovably to one another.

19. A method according to claim 18, wherein the first part is a vane stub resulting from removal of a damaged portion from a vane for a gas turbine and the second part is a repair part.

20. A method according to claim 18, wherein the second part is a vane stub resulting from removal of a damaged portion from a vane for a gas turbine and the first part is a repair part.

21. A method according to claim 20, wherein:
the repair part is oversized in comparison to the damaged portion removed from the vane; and
further comprising the step of shaping the form of the repair part after attaching it to the vane stub.

22. A method according to claim 18, wherein the step of attaching the first part to the second part occurs by means of a welding procedure selected from a group of welding procedures including plasma-arc welding, TIG welding, laser-jet welding, and electron-beam welding.

23. A method according to claim 22, wherein during the welding procedure, the power supply is brought from one direction, which is at an angle to the direction of the groove depth.

24. A method according to claim 23, wherein the welding occurs so that the second part is attached to the first part in an area of the base of the groove and in the area of the groove sidewalls stretching from the base of the groove to the opening cross-section of the groove.

25. A semi-finished article for use in producing a repaired vane for a gas turbine, the repaired vane having a repaired configuration that is substantially identical to the original configuration of the vane before being damaged, the semi-finished article comprising:
a vane stub resulting from removal of a damaged portion from a vane for a gas turbine, the vane stub having an initial stub configuration that is different from the original configuration of the vane; and
a repair part having a first section, a second section and a size which is greater than the size of the damaged portion removed from the vane;
the first section corresponding to a form-fitted repair part area having the original configuration of the damaged portion of the vane before being damaged and removed;
the second section corresponding to a removal area that is removable by subsequent processing so as to leave the first section and the vane stub with a combined configuration that is substantially identical to the original configuration of the vane before being damaged;
wherein one of the repair part and the vane stub includes a groove formed thereon, the groove having a base, sidewalls and an opening cross-section; and
wherein at least a portion of the other of the repair part and the vane stub projects between the sidewalls of the groove, and the vane stub and the repair part are connected irremovably to one another.

26. A semi-finished article according to claim 25, wherein the groove is formed on the repair part, and wherein at least a portion of the groove sidewalls are disposed in the second section corresponding to the removal area.

27. A semi-finished article according to claim 26, wherein the geometry of the groove includes run-up and run-out areas for weld procedures.

28. A semi-finished article according to claim 26, further comprising welded material disposed at the groove base, the welded material connecting the repair part irremovably to the vane stub.

29. A semi-finished article according to claim 25, wherein the width of the groove is substantially constant in the depth direction.

30. A semi-finished article according to claim 25, wherein the groove is tapered in the depth direction.
